(19) United States
(12) Patent Application Publication
(10) Pub. No.: US 2023/0367870 A1
(43) Pub. Date: Nov. 16, 2023

(54) INTRUSION DETECTION IN COMPUTER SYSTEMS

(71) Applicant: Robert Bosch GmbH, Stuttgart (DE)

(72) Inventor: Paulius Duplys, Markgroeningen (DE)

(21) Appl. No.: 18/163,003

(22) Filed: Feb. 1, 2023

(30) Foreign Application Priority Data
May 13, 2022 (DE) 10 2022 204 710.9

(51) Int. Cl. G06F 21/55

(52) U.S. Cl. CPC G06F 21/552; G06F 2221/034

(57) ABSTRACT

A computer implemented method for intrusion detection performed at a first computing node. The method includes: obtaining, at the first computing node, at least one monitored characteristic of the first computing node during an operation of the first computing node associated with a state iteration of the first computing node, wherein the first monitored characteristic is indicative of an intrusion; and communicating, from the first computing node to a second computing node, the at least one monitored characteristic of the first computing node.

### CROSS REFERENCE

The present application claims the benefit under 35 U.S.C. § 119 of German Patent Application No. DE 10 2022 204 710.9 filed on May 13, 2022, which is expressly incorporated herein by reference in its entirety.

### FIELD

The present invention concerns methods for intrusion detection in computer systems, and associated apparatuses, systems, computer program elements, and computer readable media.

### BACKGROUND INFORMATION

The increasing connectivity of embedded devices to external communication networks (for example, engine control units ECUs in vehicles) increases the attack surface (for example, from cyber attacks) against such connected embedded devices. Intrusion detection is a proven method applied to detect that an intrusion into a connected embedded device, or network, is in progress. Embedded devices used in vehicular applications often have a limited computation and/or connectivity budget. Therefore, the need to perform intrusion detection must be traded off against the tasks that the embedded devices must natively perform associated with operation of a vehicle, for example. Accordingly, intrusion detection approaches for embedded devices, especially as applied to vehicular communication networks, may be further improved.

### SUMMARY

According to a first aspect of the present invention, there is provided a computer implemented method for intrusion detection performed at a first computing node. According to an example embodiment of the present invention, the method comprises:
obtaining, at the first computing node, at least one monitored characteristic of the first computing node during an operation of the first computing node associated with a state iteration of the first computing node (30), wherein the first monitored characteristic is indicative of an intrusion; and
communicating, from the first computing node to a second computing node, the at least one monitored characteristic of the first computing node.

According to a second aspect of the present invention, there is provided a computer implemented method for intrusion detection performed at a second computing node. According to an example embodiment of the present invention, the method comprises:
receiving, at the second computing node, at least one monitored characteristic of the processor of the first computing node communicated to the second computing node by the first computing node;
performing, at the second computing node, at least one state iteration of a digital model of at least a portion of the first computing node, wherein the state iteration of the digital model provides, as an output, at least one simulated characteristic that is analogous to the at least one monitored characteristic received from the first computing node;
comparing the at least one monitored characteristic of the processor of the first computing node to the at least one simulated characteristic output by the digital model; and
if a discrepancy between the at least one monitored characteristic of the processor of the first computing node and the at least one simulated characteristic output by the digital model is detected, performing a response.

In other words, the present invention provides an intrusion detection approach comprising a functional and/or behavioural model operated by a second node, of the first computing node, and/or its software stack, in a so-called digital twin, or digital model operated by the second computing node. A functional model is an exact copy of the software stack executed by the first computing node that is driven by the same instructions as applied to the first computing node. A behavioural model is not an exact copy of the software stack executed by the first computing node, but instead includes timing definitions, power consumption models, and the like. The behavioural model may receive the same instructions as applied to the first computing node, and predict expected timing or power consumption behaviour using the instructions.

The digital model comprises an up-to-date representation of the processor, software stack, and/or IO configuration of the first computing node. If software updates are applied to the software stack operated by the first computing node, then the digital model operated by the second computing node is also updated with the same software update, or the behavioural model amended to reflect the software update. As the first computing node performs processing tasks, the digital model at the second computing node can perform the same processing tasks. The digital model at the second computing node is assumed to be protected from cyber intrusion that could target the first computing node. In the case of a functional model, the executed by the second node as the digital twin is assumed to be protected by effective firewalls that prevent an intruder to the first computing node also interfering with the digital twin. In the case of a behavioural model of the first computing node operated by the second computing node, the behavioural model will not respond to cyber intrusion attempts, because the behavioural model would not contain software modules accessible to a cyber intruder.

Therefore, the second computing node can monitor characteristics of the first computing node and report discrepancies at the first computing node as potential indications of cyber intrusion.

According to a third aspect of the present invention, there is provided a first computing node for intrusion detection comprising a first processor, a first memory, a first communication interface, and a monitoring engine. The first processor is configured to perform the method according to the first aspect, or its embodiments.

According to a fourth aspect of the present invention, there is provided a second computing node comprising a second processor, a second memory, and a second communication interface. The second processor is configured to perform the method according to the second aspect, or its embodiments.

According to a fifth aspect of the present invention, there is provided a computer implemented method of intrusion detection comprising:
obtaining, at a first computing node, at least one monitored characteristic of a processor of the first computing node during an operation of the processor that is indicative of an intrusion (FIG. 7, 71);
communicating, from the first computing node to a second computing node, the at least one characteristic of the processor of the first computing node (FIG. 7, 72);
performing, at the second computing node, at least one state iteration of a digital model of at least a portion of the first computing node, wherein the state iteration of the digital model provides, as an output, at least one simulated characteristic that is analogous to the at least one characteristic received from the processor of the first computing node (FIG. 7, 73);
comparing the at least one characteristic of the processor of the first computing node to the at least one simulated characteristic output by the digital model (FIGS. 7, 74); and
if a discrepancy between the at least one characteristic of the processor of the first computing node and the at least one simulated characteristic output by the digital model is detected, performing a response (FIG. 7, 75).

According to a sixth aspect, there is provided a system comprising a first computing node according to the third aspect, a second computing node according to the fourth aspect, and a communications network configured to communicably couple at least the first and second computing nodes.

According to a seventh aspect, there is provided a computer program element comprising machine readable instructions which, when executed by a processor, cause the processor to perform the steps according to (i) the first aspect, or its embodiments and/or (ii) the second aspect, or its embodiments.

According to an eighth aspect, there is provided a computer readable medium comprising the computer program element according to the seventh aspect.

### BRIEF DESCRIPTION OF THE DRAWINGS

FIG. 1 schematically illustrates a first intrusion detection according to an example embodiment of the present invention.

FIG. 2 schematically illustrates a second intrusion detection, according to an example embodiment of the present invention.

FIG. 3 schematically illustrates a method of a first computing node according to the first aspect of the present invention.

FIG. 4 schematically illustrates a method of a second computing node according to the second aspect of the present invention.

FIG. 5 schematically illustrates a first computing node according to the third aspect of the present invention.

FIG. 6 schematically illustrates a second computing node according to the fourth aspect of the present invention.

FIG. 7 schematically illustrates a method according to a fifth aspect of the present invention.

FIG. 8 schematically illustrates an example of a characteristic monitored at a first computing node that can indicate an intrusion, according to an example embodiment of the present invention.

FIG. 9 schematically illustrates a system according to a sixth aspect of the present invention.

### DETAILED DESCRIPTION OF EXAMPLE EMBODIMENTS

### A. General

With the increasing connectivity of embedded systems, securing embedded devices against cyber attacks becomes a priority. For example, vehicles comprise tens or hundreds of microcontrollers, microprocessors, and computers, referred to as electronic control units (ECUs). The ECUs are connected by an in-vehicle network (IVN) using, for example, CAN, LIN, automotive Ethernet, or other network technology. A trend is that connectivity from a vehicle network to external entities such as wireless base stations or other vehicle networks is increasing. ECUs themselves are increasingly being replaced by more centralized processors having higher performance. In turn, these improved ECUs run software that is progressively becoming more complex. Therefore, in-vehicle networks are becoming an increasingly attractive target for cyber criminals and other parties interested in compromising in-vehicle networks. For example, existing messages could be manipulated, or extra messages could be injected into the IVN, and such events could lead to safety risks.

An intrusion detection and prevention system IDPS is configured, for example, to monitor an embedded computer system, and to detect successful and unsuccessful attempts at comprising the embedded computer system. For example, an IDPS may detect spoofed messages, injected messages, or manipulated messages on a CANBUS network, and act in response to such detection. An example of such an action is shutting down components or functions, or preventing compromised components from sending further messages, generating a log message, or informing a remote monitoring centre. If the embedded computer system monitored by the IDPS is incorporated in a vehicle, the IDPS may inform the driver of the vehicle. In other domain areas outside of the vehicular domain (such as a web server, for example), a response to the detection of an intrusion could involve locking or shutting down the server upon detection of an intrusion.

Existing intrusion detection systems have limitations. If observations of the state of an embedded device, or its behaviour or inputs are analysed on the embedded device itself, the analysis should be so simple that the analysis can be run in a resource constrained environment on the embedded device. There is a risk that sophisticated cyber intrusion attempts will not be detected.

If observations of the state of the embedded device are made off, or outside, the embedded device (for example, by another processor such as an IDPS operating as an edge node, or on a remote server or in a cloud service), there is no limitation in terms of the available computational resources that can be brought to bear on the cyber intrusion problem.

However in this case, a large amount of data must be transmitted from the monitored embedded device to the place where the analysis is performed, thereby significantly increasing operational cost. A communication link capable of sustaining such communication may not always be available. The present specification provides an approach enabling relatively complex analyses to be performed, at the same time as requiring the transmission of relatively small amounts of data between the monitored device and a monitoring intrusion detection and prevention system. In the present application, a “first computing node” is the monitored device, and the “second computing node” is the intrusion detection and prevention system.

In the present specification, a digital twin is a stateful model of a processor, and optionally its input, output and memory interfaces, along with the software executed by the processor. The digital twin provides an up-to-date digital representation (of all, or of selected aspects) of the physical device. A digital twin is typically operated in an edge node or in a cloud backend. In an example, the digital twin executed at the second computing node comprises a duplicate representation of the software stack and memory space associated with the processor of the first computing node.

In an example, the digital twin executed at the second computing node comprises a duplicate representation of the register file associated with the processor of the first computing node. In an example, the digital twin executed at the second computing node comprises a parametric model of power consumption, bus voltage, bus current, or temperature of the hardware of the first computing node, or a model of one or more elapsed times required to complete a predefined task at the first computing node.

Since the software running on the first computing node is known to a manufacturer, simulators can be used to predict selected digital and physical properties of the first computing node. For example, an instruction set stimulator can be used to predict the register values, and power simulator can be used to predict power consumption of the first computing node based on the knowledge of the input, internal state, and the software executed by the first computing node.

A specific example of cyber intrusion attacks that the monitored node can be protected against using this technique are code injection attempts, or control flow hijacking attempts. Although the specification primarily discusses vehicular networks, embedded control units in industrial control units, network connected sensors, network connected lighting systems, and network connected electrical tools such as drills are also exemplary fields application of the technique.

Electronic control units have digital and physical properties that are highly correlated to their internal operation, and that can be represented in a compact manner.

For example, a hash of the register file of an embedded processor is an example of the current state of the embedded processor at the time that the hash is made. A monitored processor may be requested to invoke a specific API interface, to compute one or more mathematical functions in a unique sequence, to read or to write specific memory locations to the register, or to locations and volatile and/or non-volatile memory.

The monitored processor can then transmit a sample of the register file or another part of monitored memory to the monitoring processor. In parallel, the monitoring processor may perform an analogous request using a digital twin executed by the monitored processor. The monitoring processor can compare the result (such as a register file) of the initial request performed by the monitored processor, with the result (such as a virtual register file) of the analogous request performed by the digital twin. Discrepancies between the register file of the monitored device with the virtual register file generated by the digital twin and the monitoring device indicate the presence of a cyber intrusion on the monitored device.

As another example, a power consumption pattern of an embedded processor is an example of a state transition of the embedded processor over a given time range. A specific computational task may be addressed to the monitored processor, such as a request to find a solution of a complicated mathematical function (using the Newton Rapson method for example), or a command to write a large amount of pseudorandom data to memory. The monitoring device performs the analogous command on the digital twin executed by the monitoring device. The monitored power consumption profile of the monitored device is transmitted by the monitored device to the monitoring device. Discrepancies between the power consumption profiles can indicate that unexpected or hidden software modules are being executed by the monitored device, thus indicating the presence of a cyber intrusion.

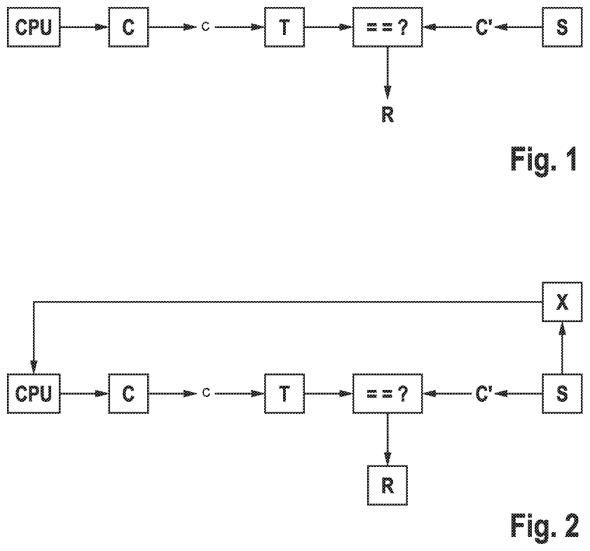

FIG. 1 schematically illustrates a first intrusion detection according to an example embodiment of the present invention.

In FIG. 1, a dedicated collector module C inside a first computing node can be implemented either in software, or in hardware, or both. The dedicated collector module C collects dedicated characteristics (denoted c) and transmits them to a digital twin T operating in a second computing node. For example, the second computing node may reside in an edge node, or cloud backend. A simulator (digital twin, digital model) in the second computing node S computes an expected characteristic c′ that is expected to be observed at the CPU. The actual characteristics c are then compared to the expected characteristics c′. If a match does not occur, a response R is initiated. The definition of whether or not a match occurs depends on the quantities measured at the first computing node by the dedicated collector module C.

For example, if the collector module C is configured to monitor the register file associated with the CPU, a bitwise comparison of the register file associated with the CPU and the register file associated with the digital twin is performed. Non-compliances or differences between the bitwise comparison of the register files indicates that a response should be initiated. In the case that the monitored characteristic c is continuous, for example is the power consumption and/or the temperature of the processor at the first computing node (CPU), the non-compliance may be detected by comparing the actual characteristics with a thresholded parametric model operated by the digital twin.

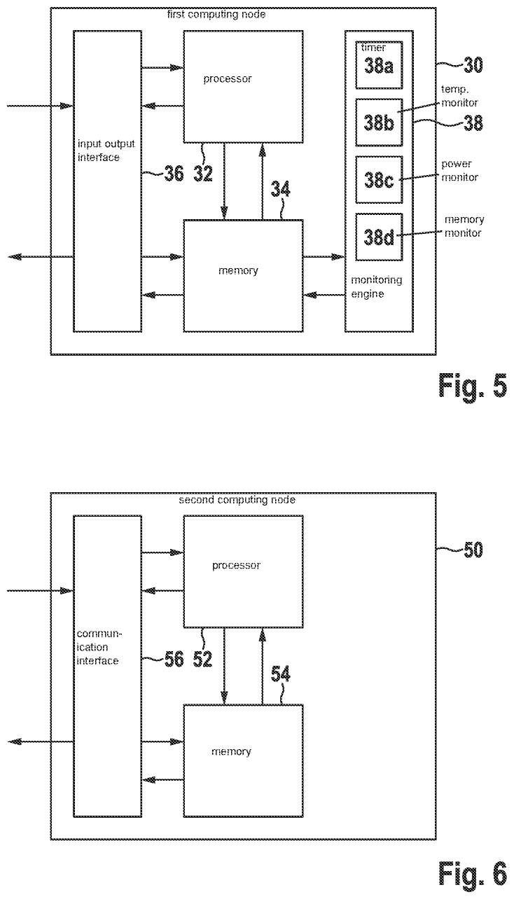

Considering briefly the representations of FIGS. 5, 6, and 9, the response R performed by the second computing node is that the first computing node 30 is marked in a database 90 is being suspicious, or less trustworthy. In an example, a distributed system 80 may prevent messages from being routed to the first computing node 30. In an example, a response R is for the second computing node 50 or the distributed system 80 to disable or to power down the first computing node 30. In an example, the response R is to download software update to the first computing node (CPU) 30, to initiate an antivirus scan of the first computing node 30, or to reflash firmware of the first computing node 30 via an over the air update. According to an example, the second computing node 50 and/or the distributed system 80 initiate a reboot of the first computing node 30. According to example, the second computing node 50 and/or the distributed system 80 initiate an additional diagnostic software agent in the first computing node 30.

FIG. 2 schematically illustrates a second intrusion detection according to an example embodiment of the present invention.

The modules of the intrusion detection concept of FIG. 1 perform the same functions as discussed above. In the second intrusion detection concept, an additional module X is configured to generate predefined or random challenges that are communicated both to the first computing node 30, and to the simulator S (digital twin or digital model) executed by the second computing node 50. Both S and the first computing node CPU execute the challenges. The resulting characteristics c and c′ are compared to each other. If the resulting characteristics do not match to each other, a response is initiated as described in the example of FIG. 1.

Therefore, the characteristic c is a compact representation of the state of the first computing node 30. The term “state” refers to any parameter associated with the first computing node 30 that can be affected by software executed by the first computing node 30. Most generally, the logical state of the register file and/or the logical state of the memory 34 associated with a processor 32 of the first computing node 30 is an example of the state of the first computing node 30. In this sense, the term “state” represents an actual position in the control flow of a program executed by the processor 32 of the first computing node 30, and is the most exact representation of “state”. Alternatively, or in addition, the “state” may be a less exact representation of the first computing node 30. For example, the “state” could be a list of active software processes in the first computing node 30, a list of all software processes that have ever operated in the first computing node 30, a list of all software processes that have operated in the first computing node 30 during a predetermined time window, a list of network addresses of other network-connected computing nodes that are, or have been communicably coupled to the first computing node 30. The term “state” may also refer to a current operating temperature of a processor 32, a current clock speed of the processor 32, a current power consumption of the processor 32, and the like.

Therefore, a “state iteration” of the first computing node covers a correspondingly broad range of changes that the first computing node 30 experience, based on the “state” that is monitored. A state iteration can be a change in the register file based on a branching of the control flow of a program executed by the first computing node 30. A “state iteration” of the first computing node may be the provision of a result of a special computation. A “state iteration” may be a definition of which software applications are running at a given or past time. A “state iteration” may be a change in the list of other computing nodes that communicate with the first computing node over a communications network. A “state iteration” may be a change in processor temperature, power consumption, and/or clock speed of the first processor 32.

Transmitting the characteristic c representing the “state” to a second computing node 50 or external database 90, or an associated edge device or cloud service implies little communication overhead. Instead of implementing large-scale detection software on the first computing node 30, the detection is performed at the second computing node 50 which may have more computational power. The rationale is that the manufacturer is aware in advance of the software configuration of the first computing node 30, enabling the second computing node 50 to accurately determine the behaviour of the first computing node 30. Beneficially, the computational resources at the second computing node 50 are not constrained compared to the competition resources of the first computing node 30. Therefore, more subtle cyber security exploits can be detected by the second computing node 50.

If a malware exploit executes on the first computing node 30, and the collector C is implemented at the first computing node 30 as a hardware element, then the collector C cannot be manipulative by the malware exploit.

If the collector C is implemented in software, then the malware could manipulate C and send arbitrary values to the digital model executed by the second computing node 50. However, in order to return the correct values for the measured characteristic c, an attacker would need to record all legitimate values of c, and store them within the malware on the first computing node 30. In practice, the memory 34 on the first computing node 30 is of limited size, and that such an approach is unlikely to be successful.

With the enhancement of FIG. 2, an attacker cannot predict the correct values of the measured characteristic c of the first node 30 even having full knowledge of the legitimate software. The malware itself would need to simulate the legitimate software. Due to resource constraints on the processor 32 of the first computing node 30, this is practically infeasible.

### B. Remote Intrusion Monitoring

Throughout this specification, the behaviour of the monitored computing node (first computing node) is discussed in association with the first aspect. The behaviour of the monitoring computing node (second computing node) is discussed in association with the second aspect. As an aid to presentation, sections B to E discuss various embodiments of the concept from the point of view of the first node and the second node. In the aspects of section B the first computing node 30 is configured to measure a monitored characteristic of the first computing node 30, and to communicate monitored characteristic to a second computing node 50. The second computing node 50 executes a digital model of the first computing node 30. The second computing node 50 is configured to detect a discrepancy indicating the presence of malware in the first computing node 30, and to generate a response.

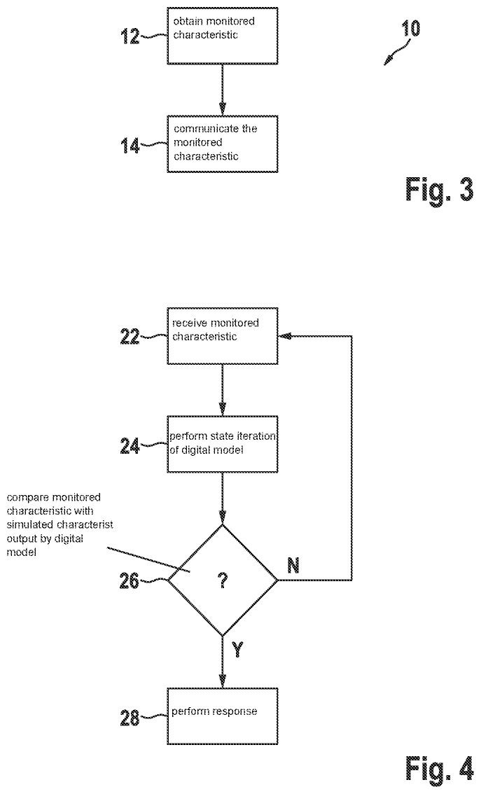

FIG. 3 schematically illustrates a method of a first computing node 30 according to the first aspect of the present invention.

According to a first aspect, there is provided a computer implemented method 10 for intrusion detection performed at a first computing node 30 comprising:
obtaining 12, at the first computing node 30, at least one monitored characteristic of the first computing node during an operation of the first computing node associated with a state iteration of the first computing node 30, wherein the first monitored characteristic is indicative of an intrusion; and
communicating 14, from the first computing node 30 to a second computing node 50, the at least one monitored characteristic of the first computing node 30.

A characteristic monitoring engine 38 of the first computing node 30 is configured to monitor one or more of the processor 32, memory 34, and/or input output interface 36 of the first computing node 30. According to an embodiment, the characteristic monitoring engine 38 comprises a timer 38a. The timer 38a may time a duration of the process executed by the processor 32. For example, the timer 38a may monitor one or more times associated with one or more corresponding programme branches of a program executed by the processor 32. The timer 38a may monitor one or more times associated with one or more corresponding preset computations.

According to an embodiment, the characteristic monitoring engine 38 comprises a temperature monitor 38b. The temperature monitor 38b is configured to obtain the die temperature of the integrated circuit comprising the processor 32 and/or the memory 34, for example.

According to an embodiment, the characteristic monitoring engine 38 comprises a power monitor 38c. the power monitor 38c is capable of monitoring the overall power consumption of the first computing node 30, alternatively the power consumption of subunits of the first computing node 30. For example, the power monitor 38c is configured to monitor the power consumption of the processor 32, memory 34, and I/O interface separately.

According to an embodiment, the characteristic monitoring engine 38 comprises a memory monitor 38d enabling the characteristic monitoring engine 38 to obtain, for example, a bitwise representation of a register file or memory pages associated with the first computing node 30.

According to an embodiment, the at least one monitored characteristic is a register hash of the first computing node 30, a power consumption, bus voltage, bus current, or temperature measurement of the hardware of the first computing node 30, or an elapsed time required to complete a predefined task at the first computing node 30.

FIG. 4 schematically illustrates a method of a second computing node 50 according to the second aspect of the present invention.

According to a second aspect, there is provided a computer implemented method 20 for intrusion detection performed at a second computing node 50 comprising:
receiving 22, at the second computing node 50, at least one monitored characteristic of the processor of the first computing node 30 communicated to the second computing node by the first computing node associated with a corresponding state iteration of the first computing node 30;
performing 24, at the second computing node 50, at least one state iteration of a digital model of at least a portion of the first computing node 30 that mimics the state iteration of the first computing node 30, wherein the state iteration of the digital model provides, as an output, at least one simulated characteristic that is analogous to the at least one monitored characteristic received from the first computing node 30;
comparing 26 the at least one monitored characteristic of the processor of the first computing node 30 to the at least one simulated characteristic output by the digital model; and
if a discrepancy between the at least one monitored characteristic of the processor of the first computing node 30 and the at least one simulated characteristic output by the digital model is detected, performing 28 a response.

For example, the digital model is a copy of an operating system, and its component applications, executed by the first computing node 30. In an example, the digital model is a parametric model of the first computing node 30 capable of modelling the power consumption and/or temperature of the first computing node 30 based on the computer operation is performed by the first computing node 30.

### C. Remote Intrusion Monitoring According to Instruction from Remote Computing Node

As a further example, if a first computing node is given the task by a second computing node of computing specifically chosen challenges, malware running on the first computing node cannot pre-compute correct values for the selected digital and physical properties of the first computing node, enabling the malware to be detected. In an example, the challenges can be randomly chosen.

According to an embodiment of the second aspect, there is provided transmitting, to the first computing node 30, at least one instruction to perform a processing operation at the first computing node 30, and at least one corresponding instruction to monitor a characteristic of the first computing node 30 associated with the at least one instruction to perform a processing operation;
wherein the at least one state iteration of the digital model of at least a portion of the first computing node 30 is performed based on the at least one instruction to perform a processing operation at the first computing node 30.

For example, a computer operation to be executed by the first computing node 30 may be a proof of work operation. In an embodiment, the computer operation is a computation of a prime number. In an embodiment, the computer operation is a sorting operation. In an embodiment, the computer operation is a memory permutation operation comprising writing large blocks of memory of the first computing node 30. A skilled person will be able to define other suitable computer operations. By transmitting an instruction to the first computing node 30, the second computing node 50 has a large amount of control in what the processing operation transmitted to the first computing node 30 is. The instruction may be, for example, a code snippet or function defining a processing challenge having a complexity that is customised to the existing threat environment.

According to an embodiment of the first aspect, there is provided:
receiving, from the second computing node 50, an instruction to perform a processing operation at the first computing node 30 and at least one corresponding instruction to monitor a characteristic of the first computing node 30 associated with the at least one instruction to perform a processing operation;
performing the processing operation at the first computing node 30 as defined in the instruction; and
wherein communicating, from the first computing node 30 to a second computing node 50, the at least one characteristic of the first computing node 30 comprises communicating at least one monitored characteristic to the second computing node 50 after the processing operation at the first computing node 30 as defined in the instruction has been performed.

Accordingly, the first computing node 30 is configured to receive the instruction to perform a computer operation, and to measure the characteristic of interest as the processing operations being performed.

Therefore, the second computing node 50 is configured to select an operation, and define an instruction, for performing a processing operation at the first computing node 30. In an embodiment, the second computing node 50 comprises a library of functions or computational tasks that can be transmitted to the first computing node 30 as the instruction to perform the processing operation. In another embodiment, the first computing node 30 comprises a store of computing operations in memory 34. Each computing operation in the store of computing operations is indexed with a unique identifier. The second computing node 50 is configured to transmit, as the at least one instruction, an identifier to identify a computer operation in memory 34 that the first computing node 30 should execute.

In parallel, the digital model operated by the second computing node 50 also models the execution of the computer operation that the first computing node 30 has been instructed perform. In the case of a logical calculation operation, a discrepancy may be identified by the second computing node 50 if the result of the computer operation output by the digital model does not correspond to the at least one monitored characteristic received from the first computing node 30.

According to an embodiment, the at least one instruction to perform a processing operation at the first computing node 30 comprises an instruction to execute code within a predefined code segment, to access a predefined memory location or communication bus, or to access or toggle a predefined output interface.

### D. Remote Intrusion Monitoring According to Memory Identifier from Remote Computing Node

In some cases, the transfer of a code snippet or segment defining an instruction of a function that the first computing node 30 should perform may result in too much communication overhead. Furthermore, in some cases it might not be possible to distinguish between a legitimate code snippet or segment defining instruction for the first computing node 30 to perform, and a malware attack. Accordingly, the challenges that the first computing node 30 can also be securely pre-provisioned at memory locations in the memory 34 accessible to the first computing node 30. The digital model operated by the second computing node 50 also maintains a register of the challenges. In this case, only an identifier of the challenges to be executed need to be transmitted to the first computing node 30 from the second computing node 50. The benefit of this approach is that the first computing node 30 maintains an authenticated list of challenges that do not change. The authenticated list of challenges stored in the first computing node 30 is trusted, and the invocation of the challenges in the authenticated list by the second computing node 50 is known (by the first computing node 30) not to be as a result of malware intrusion.

According to an embodiment of the second aspect of the present invention, there is provided:
transmitting, to the first computing node 30, a first identifier of a memory location at the first computing node 30 that comprises the at least one instruction to perform a processing operation at the first computing node 30, and at least a second identifier of a memory location at the first computing node 30 comprising the corresponding instruction to monitor a characteristic of the first computing node 30 associated with the at least one instruction to perform a processing operation; and
obtaining, at the second computing node, the at least one instruction to perform the processing operation at the first computing node 30 by looking up the at least one instruction in a replicated memory location at the second computing node 50 based on the first identifier;
wherein the at least one state iteration of the digital model of at least a portion of the first computing node 30 is performed based on the at least one instruction to perform a processing operation at the first computing node 30 obtained based on the first identifier.

According to an embodiment of the second aspect, there is provided:
obtaining a selected processing operation at the second computing node 50 to be performed by the first computing node (30) based on a selection from a set of processing operations;
transmitting, as the at least one instruction to perform a processing operation to the first computing node 30, the selected processing operation; and
wherein performing, at the second computing node 50, the at least one state iteration of the digital model of at least a portion of the first computing node 30 is based the selected processing operation.

Another benefit of this approach is that the communication overhead is greatly reduced. Definition of the processing challenges (operation) in the first computing node 30 means that only the identifier of the authenticated challenge needs to be transferred from the second computing node 50 to the first computing node 30. The identifier may be a small as a few bits, or a byte, for example.

According to an embodiment of the first aspect, there is provided:
receiving, at the first computing node 30, a first identifier of a memory location in the first computing node 30 that comprises the at least one instruction to perform a processing operation at the first computing node 30, and a second identifier of a memory location in the first computing node 30 that comprises at least one corresponding instruction to monitor a characteristic of the first computing node 30 associated with the at least one instruction to perform a processing operation; and
retrieving the at least one instruction to perform a processing operation, and the at least one corresponding instruction to monitor a characteristic of the first computing node 30.

### E. Remote Intrusion Monitoring—Database Update

According to an embodiment of the second aspect, the response of the second computing node 50 comprises one or more of:
entering, into a database 90, an entry defining an altered trust level of the first computing node 30;
sending a message to the first computing node 30 instructing the first computing node 30 to reboot;
transmitting firmware to the first computing node 30, and instructing the first computing node 30 to install the firmware;
sending a message to the first computing node 30 instructing the first computing node 30 to operate according to a reduced functionality set; and/or
communicating an alert to a central monitoring service.

### F. Other Aspects

FIG. 5 schematically illustrates a first computing node 30 according to the third aspect of the present invention.

According to a third aspect, there is provided a first computing node 30 for intrusion detection comprising a first processor 32, a first memory 34, a first communication interface 36 and a monitoring engine 38. The first processor 32 is configured to perform the method according to the method of the first aspect, or its embodiments.

The characteristic monitoring engine 38 of the first computing node 30 is configured to monitor one or more of the processor 32, memory 34, and/or input output interface 36 of the first computing node 30. According to an embodiment, the characteristic monitoring engine 38 comprises a timer 38a. The timer 38a may time a duration of the process executed by the processor 32. For example, the timer 38a may monitor one or more times associated with one or more corresponding programme branches of a program executed by the processor 32. The timer 38a may monitor one or more times associated with one or more corresponding preset computations.

According to an embodiment, the characteristic monitoring engine 38 comprises a temperature monitor 38b. The temperature monitor 38b is configured to obtain the die temperature of the integrated circuit comprising the processor 32 and/or the memory 34, for example.

According to an embodiment, the characteristic monitoring engine 38 comprises a power monitor 38c. the power monitor 38c is capable of monitoring the overall power consumption of the first computing node 30, alternatively the power consumption of subunits of the first computing node 30. For example, the power monitor 38c is configured to monitor the power consumption of the processor 32, memory 34, and I/O interface separately.

According to an embodiment, the characteristic monitoring engine 38 comprises a memory monitor 38d enabling the characteristic monitoring engine 38 to obtain, for example, a bitwise representation of a register file or memory pages associated with the first computing node 30.

FIG. 6 schematically illustrates a second computing node 50 according to the fourth aspect.

According to a fourth aspect, there is provided a second computing node 50 comprising a second processor 52, a second memory 54, a second communication interface 56, wherein the second processor 52 is configured to perform the method according to the second aspect, or its embodiments.

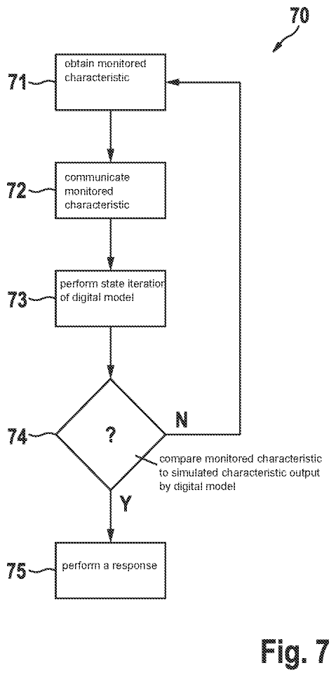

FIG. 7 schematically illustrates a method according to a fifth aspect of the present invention.

According to the fifth aspect, there is provided a computer implemented method of intrusion detection in a system performing at least the steps of the first aspect and the steps of the second aspect.

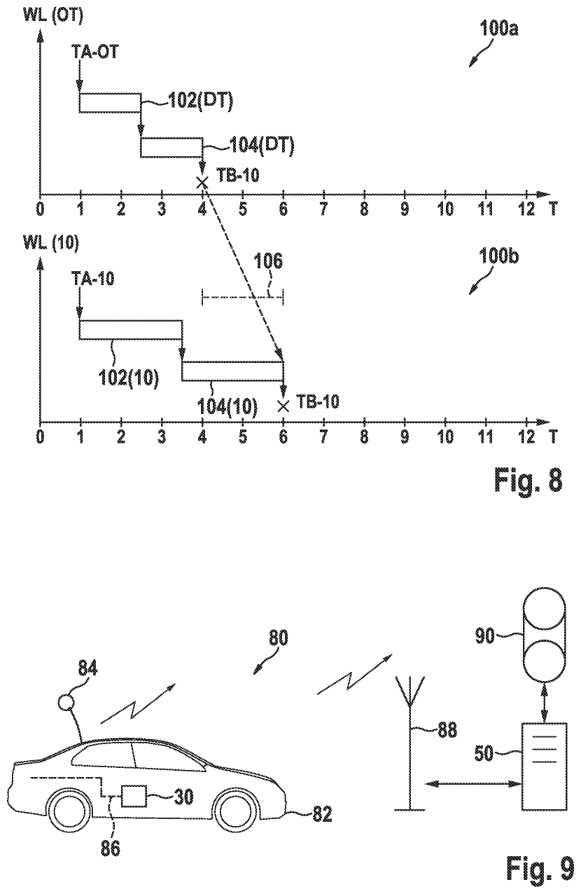

FIG. 8 schematically illustrates an example of a characteristic monitored at a first computing node that can indicate an intrusion.

For example, plot 100a represents a simulated workload WL produced by a digital twin at the second computing node 50 against time. Plot 100b represents a real workload WL of a first computing node 30 against time. In this example, the second computing node 50 is configured to perform successive first 102(DT) and second 104(DT) processing operations using a digital model. Instructions defining the first 102 and second 104(DT) processing operations are transmitted from the second computing node 50 to the first computing node 30.

Alternatively, the instructions defining the first 102 and second 104 processing operations are available to the first computing node 30 in the memory 34 of the first computing node 30, and the second computing node 50 transmits identifiers to the first computing node 30. The digital model executed by second computing node begins the first task at T=1, and finishes the second task at T=4. The processor of the first computing node 10 begins the first task at T=1, and finishes the second task at T=6, as detected by the monitoring engine 38 of the first computing node 30 and communicated to the second computing node 50.

Accordingly, both the first task 102(DT) and the second task 104(DT) are determined to have taken longer to execute by time difference as compared to the digital model executed by the second computing node 50. The second computing node 50 can determine from this that a malware intrusion may be slowing down the processor 32 of the first computing node 30.

FIG. 9 schematically illustrates a system according to the sixth aspect.

According to a sixth aspect, there is provided a system 80 comprising a first computing node 30 according to the third aspect or its embodiments, and a second computing node according to the fourth aspect, or its embodiments, and a communications network 88 configured to communicably couple at least the first 30 and second 50 computing nodes.

In an example, the first computing node 30 is comprised in a vehicle and is communicably coupled to an antenna 84 via a vehicular communications network 86. The antenna 84 is configured to transfer data to a base station 88. The base station 88 is communicably coupled to the second computing node 50 and/or a database 90. In an example, the second computing node 50 hosts an intrusion detection and prevention system.

According to a seventh aspect, there is provided a computer program element comprising machine readable instructions which, when executed by a processor, cause the processor to perform the steps according to (i) the first aspect, or its embodiments and/or (ii) the second aspect, or its embodiments.

According to an eighth aspect, there is provided a computer readable medium comprising the computer program element according to the seventh aspect.

The computer readable medium is configured to store a computer program, application, logic including machine code capable of being executed by a processor. The computer readable medium includes RAM, ROM, EEPROM, and other devices that store information that may be used by the processor. In examples, the processor and the computer readable medium are integrated on the same silicon die, or in the same packaging. In examples, the computer readable medium is a hard disc drive, solid state storage device, or the like. In an example, the signal may be communicated over a data communication network such as the Internet as a download, or software update, for example.

The examples provided in the figures and described in the foregoing written description are intended for providing an understanding of the principles of this specification. No limitation to the scope of the present invention is intended thereby. The present specification describes alterations and modifications to the illustrated examples. Only the preferred examples have been presented, and all changes, modifications and further applications to these within the scope of the specification are desired to be protected.

What is claimed is:

1. A computer implemented method for intrusion detection performed at a first computing node, the method comprising:
obtaining, at the first computing node, at least one monitored characteristic of the first computing node during an operation of the first computing node associated with a state iteration of the first computing node, wherein the first monitored characteristic is indicative of an intrusion; and
communicating, from the first computing node to a second computing node, the at least one monitored characteristic of the first computing node.

2. The computer implemented method according to claim 1, further comprising:
receiving, from the second computing node, an instruction to perform a processing operation at the first computing node and at least one corresponding instruction to monitor a characteristic of the first computing node associated with the at least one instruction to perform a processing operation; and
performing the processing operation at the first computing node as defined in the instruction;
wherein the communicating, from the first computing node to a second computing node, the at least one characteristic of the first computing node includes communicating the at least one monitored characteristic to the second computing node after the processing operation at the first computing node as defined in the instruction has been performed.

3. The computer implemented method according to claim 2, further comprising:
receiving, at the first computing node, a first identifier of a memory location in the first computing node that includes the at least one instruction to perform a processing operation at the first computing node, and a second identifier of a memory location in the first computing node that includes at least one corresponding instruction to monitor a characteristic of the first computing node associated with the at least one instruction to perform a processing operation; and
retrieving the at least one instruction to perform a processing operation, and the at least one corresponding instruction to monitor a characteristic of the first computing node.

4. The computer implemented method according to claim 2, wherein the at least one instruction to perform a processing operation at the first computing node includes an instruction to execute code within a predefined code segment, or to access a predefined memory location or communication bus, or to access or toggle a predefined output interface.

5. The computer implemented method according to claim 1, wherein the at least one monitored characteristic is a register hash of the first computing node, or a power consumption, or a bus voltage, or a bus current, or a temperature measurement of hardware of the first computing node, or an elapsed time required to complete a predefined task at the first computing node.

6. A computer implemented method performed at a second computing node for detecting an intrusion at a first computing node, the method comprising the following steps:
receiving, at the second computing node, at least one monitored characteristic of a processor of the first computing node communicated to the second computing node by the first computing node associated with a corresponding state iteration of the first computing node;
performing, at the second computing node, at least one state iteration of a digital model of at least a portion of the first computing node that mimics the state iteration of the first computing node, wherein the state iteration of the digital model provides, as an output, at least one simulated characteristic that is analogous to the at least one monitored characteristic received from the first computing node;
comparing the at least one monitored characteristic of the processor of the first computing node to the at least one simulated characteristic output by the digital model; and
based on detecting a discrepancy between the at least one monitored characteristic of the processor of the first computing node and the at least one simulated characteristic output by the digital model, performing a response.

7. The computer-implemented method of claim 6, further comprising:
transmitting, to the first computing node, at least one instruction to perform a processing operation at the first computing node, and at least one corresponding instruction to monitor a characteristic of the first computing node associated with the at least one instruction to perform a processing operation;
wherein the at least one state iteration of the digital model of at least a portion of the first computing node is performed based on the at least one instruction to perform a processing operation at the first computing node.

8. The computer implemented method according to claim 6, further comprising:
transmitting, to the first computing node, a first identifier of a memory location at the first computing node that includes the at least one instruction to perform a processing operation at the first computing node, and at least a second identifier of a memory location at the first computing node including a corresponding instruction to monitor a characteristic of the first computing node associated with the at least one instruction to perform a processing operation; and
obtaining, at the second computing node, the at least one instruction to perform the processing operation at the first computing node by looking up the at least one instruction in a replicated memory location at the second computing node based on the first identifier;
wherein the at least one state iteration of the digital model of at least a portion of the first computing node is performed based on the at least one instruction to perform a processing operation at the first computing node obtained based on the first identifier.

9. The computer implemented method according to claim 6, further comprising:
obtaining a selected processing operation at the second computing node to be performed by the first computing node based on a selection from a set of processing operations;
transmitting, as the at least one instruction to perform a processing operation to the first computing node, the selected processing operation; and
wherein the performing, at the second computing node, of the at least one state iteration of the digital model of at least a portion of the first computing node is based the selected processing operation.

10. The computer implemented method according to claim 6, wherein the response of the second computing node includes one or more of the following:
entering, into a database, an entry defining an altered trust level of the first computing node; and/or
sending a message to the first computing node instructing the first computing node to reboot; and/or
transmitting firmware to the first computing node, and instructing the first computing node to install the firmware; and/or
sending a message to the first computing node instructing the first computing node to operate according to a reduced functionality set; and/or
communicating an alert to a central monitoring service.

11. A first computing node for intrusion detection, comprising:
a first processor;
a first memory;
a first communication interface; and
a monitoring engine;
wherein the first processor is configured to:
obtain, at the first computing node, at least one monitored characteristic of the first computing node during an operation of the first computing node associated with a state iteration of the first computing node, wherein the first monitored characteristic is indicative of an intrusion; and
communicate, from the first computing node to a second computing node, the at least one monitored characteristic of the first computing node.

12. A second computing node, comprising:
a second processor;
a second memory; and
a second communication interface;
wherein the second processor is configured to detect an intrusion at a first computing node, second processor configured to:
receive, at the second computing node, at least one monitored characteristic of a processor of the first computing node communicated to the second computing node by the first computing node associated with a corresponding state iteration of the first computing node;
perform, at the second computing node, at least one state iteration of a digital model of at least a portion of the first computing node that mimics the state iteration of the first computing node, wherein the state iteration of the digital model provides, as an output, at least one simulated characteristic that is analogous to the at least one monitored characteristic received from the first computing node;
compare the at least one monitored characteristic of the processor of the first computing node to the at least one simulated characteristic output by the digital model; and
based on detecting a discrepancy between the at least one monitored characteristic of the processor of the first computing node and the at least one simulated characteristic output by the digital model, perform a response.

13. A computer implemented method of intrusion detection, comprising the following steps:
obtaining, at a first computing node, at least one monitored characteristic of the first computing node during an operation of the first computing node associated with a state iteration of the first computing node, wherein the first monitored characteristic is indicative of an intrusion;
communicating, from the first computing node to a second computing node, the at least one monitored characteristic of the first computing node;
receiving, at the second computing node, the at least one monitored characteristic of a processor of the first computing node communicated to the second computing node by the first computing node associated with the corresponding state iteration of the first computing node;
performing, at the second computing node, at least one state iteration of a digital model of at least a portion of the first computing node that mimics the state iteration of the first computing node, wherein the state iteration of the digital model provides, as an output, at least one simulated characteristic that is analogous to the at least one monitored characteristic received from the first computing node;
comparing the at least one monitored characteristic of the processor of the first computing node to the at least one simulated characteristic output by the digital model; and
based on detecting a discrepancy between the at least one monitored characteristic of the processor of the first computing node and the at least one simulated characteristic output by the digital model, performing a response.

14. A system, comprising:
a first computing node, including:
a first processor,
a first memory,
a first communication interface, and
a monitoring engine,
wherein the first processor is configured to:
obtain, at the first computing node, at least one monitored characteristic of the first computing node during an operation of the first computing node associated with a state iteration of the first computing node, wherein the first monitored characteristic is indicative of an intrusion; and
communicate, from the first computing node to a second computing node, the at least one monitored characteristic of the first computing node;
a second computing node, including
a second processor;
a second memory; and
a second communication interface;
wherein the second processor is configured to detect an intrusion at the first computing node, second processor configured to:
receive, at the second computing node, the at least one monitored characteristic of a processor of the first computing node communicated to the second computing node by the first computing node associated with a corresponding state iteration of the first computing node,
perform, at the second computing node, at least one state iteration of a digital model of at least a portion of the first computing node that mimics the state iteration of the first computing node, wherein the state iteration of the digital model provides, as an output, at least one simulated characteristic that is analogous to the at least one monitored characteristic received from the first computing node,
compare the at least one monitored characteristic of the processor of the first computing node to the at least one simulated characteristic output by the digital model, and
based on detecting a discrepancy between the at least one monitored characteristic of the processor of the first computing node and the at least one simulated characteristic output by the digital model, perform a response; and
a communications network configured to communicably couple at least the first and second computing nodes to one another.

15. A non-transitory machine readable medium on which are stored machine readable instructions for detecting by a second computing node an intrusion at a first computing node, the instruction, when executed by a processor, causing the processor to perform the following steps:
receiving, at the second computing node, at least one monitored characteristic of a processor of the first computing node communicated to the second computing node by the first computing node associated with a corresponding state iteration of the first computing node;
performing, at the second computing node, at least one state iteration of a digital model of at least a portion of the first computing node that mimics the state iteration of the first computing node, wherein the state iteration of the digital model provides, as an output, at least one simulated characteristic that is analogous to the at least one monitored characteristic received from the first computing node;
comparing the at least one monitored characteristic of the processor of the first computing node to the at least one simulated characteristic output by the digital model; and
based on detecting a discrepancy between the at least one monitored characteristic of the processor of the first computing node and the at least one simulated characteristic output by the digital model, performing a response.
